(19) United States
(12) Patent Application Publication
(10) Pub. No.: US 2021/0362357 A1
(43) Pub. Date: Nov. 25, 2021

(54) OUT OF THE FRONT KNIFE WITH LINEAR GUIDED RAIL MECHANISM

(71) Applicant: John Thomas Anastasio, Moonachie, NJ (US)

(72) Inventor: John Thomas Anastasio, Moonachie, NJ (US)

(21) Appl. No.: 16/879,755

(22) Filed: May 20, 2020

(51) Int. Cl. B26B 1/08

(52) U.S. Cl. CPC B26B 1/08

(57) ABSTRACT

This invention a significant improvement to the mechanism of “Out of the Front” knives, also known as OTF knives. This invention implements the use of linear guide rails which has never been used in the OTF knives of the prior art. The linear guide rail technology that is the subject of this invention significantly improves on the prior art by allowing for many different blade profiles, while virtually eliminating any friction between the housing and knife handle. This is a significant advantage in the industry, since people tend to value knives that can house larger blades but keeping the handle relatively small, while maintaining rigidity after repeated use. Other blade deploying technologies lack the rigidity and wear resistance that linear guide rail technology offers. This invention is a significant improvement on the prior art in the knife industry because it makes the end users product last much longer than previously designed knives.

### CROSS-REFERENCE TO RELATED APPLICATIONS

This application claims the benefit of U.S. Provisional Application No. 62/850,968, filed May 21, 2019, and which are incorporated herein by reference.

### BACKGROUND

As the name suggests, “Out of the Front” knives, also known as OTF knives, are hand-held knives generally deployed by pressing a button that releases a knife as a result the centrifugal force generated by a hand movement. Other OTF knives may be spring loaded. There are different types of knives, such as gravity knives, switchblade knives, utility knives and pocket knives, etc.

### BRIEF SUMMARY

This invention a significant improvement to the mechanism of “Out of the Front” knives, also known as OTF knives. This invention implements the use of linear guide rails which has never been used in the OTF knives of the prior art. The linear guide rail technology that is the subject of this invention significantly improves on the prior art by allowing for many different blade profiles, while virtually eliminating any friction between the housing and knife handle. This is a significant advantage in the industry, since people tend to value knives that can house larger blades but keeping the handle relatively small, while maintaining rigidity after repeated use. Other blade deploying technologies lack the rigidity and wear resistance that linear guide rail technology offers. This invention is a significant improvement on the prior art in the knife industry because it makes the end users product last much longer than previously designed knives.

In various embodiments, this invention ensures that the ejecting mechanism of the blade is sturdy and accurately repeatable after various uses over the years. In one embodiment of the invention, the retractable and ejectable blade is all done through linear guide rail technology, which is an advancement to automatic and manually deployable knives known in the prior art, since it uses a hardened single axis rail to keep the blade guided smoothly as it is ejected from the housing of the knife. Another advantage of the design that is the subject of this invention, is that the blade does not contact the inner housing of the knife when ejected and retracted, resulting in a frictionless operation that significantly improves the rigidity and reliability of the OTF knife.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a knife 100 in accordance with one embodiment. FIG. 1 is a transparent rendering of the OTF knife that is the subject of this invention.

FIG. 2 illustrates an item 200 in accordance with one embodiment. FIG. 2 is a transparent illustration of the front view of the fully ejected OTF knife that is the subject of this invention.

FIG. 3 illustrates an item 300 in accordance with one embodiment. FIG. 3 represents the linear guide rail and bearing carriage.

FIG. 4 illustrates an item 400 in accordance with one embodiment. FIG. 4 is a view of the lower frame of the OTF knife that is the subject of this invention.

FIG. 5 illustrates an item 500 in accordance with one embodiment. FIG. 5 is a view of the blade of the OTF knife that is the subject of this invention.

FIG. 6 illustrates a routine 600 for manufacturing an out-of-the-front knife assembly, in accordance with one embodiment.

### DETAILED DESCRIPTION

Previous submitted art publicly known as “Out the Front” knives or OTF Knives relies on the blade to be guided using the handle's slotted frame or channels along the inside of a knife's housing. Of these patents, the US Patent #20060112565A1 patent issued to Rocky Moser, states that a longitudinal slot and secondary longitudinal slot help guide the blade out of the handle when ejected. The shortcoming of the prior art design is that the currently used mechanisms suffer from the wear and tear of repeated usage and become faulty. Since their mechanisms are not engineered with wear resistant material, the blades become loose causing the blade ejection to not be accurately repeatable. This can lead to mechanical failures, such as their mechanism to get easily jammed or broken.

All of the known knives of the prior art use some type of guided frame/housing, which allows them to deploy and retract their blade in a linear fashion. The issue with these mechanisms in these types of knives, is that the blade is sitting within the handle of the knife and as the user ejects the blade it rubs within the inner housing of the knife causing mechanical wear which eventually leads to mechanical failure. For example, U.S. Pat. No. 7,562,455B2 relies on a central slot to keep the blade moving in a linear position. Since there is no true solid guiding system, the cutout of the handle, which guides the blade out of the handle comes in contact with the frame. Repeated ejection and retraction of the blade will wear the inside of the guided channel. This wear and tear is extremely common with these knives, eventually it will occur and cause the knife to run into some mechanical issues.

Another drawback of the design of the above-mentioned prior art blades is that in order improve rigidity and reliability, the materials must go through a hardening process that significantly the manufacturing time and cost. As opposed to the prior art, the use of the linear guide rail technology that is the subject of this invention is cost effective, since it does not rely on the knife's individual parts to be made entirely out of hardened materials.

As a significant improvement to the current state of the art, this invention uses linear guide rail technology that would allow the blade to be fixed to a bearing carriage which houses hardened ball bearings. These ball bearings ride in a channel along the rail, which will then guide the blade linearly out of the knife's frame without contacting the knife's inner housing. While the bearing carriage is well known in the prior art, the use of such a carriage in an OTF knife is novel and non-obvious.

The linear guide rail mechanism could also be fitted with a spring-loaded mechanism, rather than relying on the user to use centrifugal force, to assist the user with ejecting the knife blade out of the knife housing. The bearing carriage's ball bearings could be prone to corrosion from certain elements. An oil embedded material could replace the ball bearing design to help solve the possible issue of corrosion. A linear carriage could be fitted with or made of oil embedded and/or self-lubricating material that can help the carriage move along the linear guide rail in a less frictionless fashion.

According to one embodiment of this invention, as the blade ejects from the housing of the knife frame it will then lock in place by a spring loaded pin. The unlock/lock button allows the blade to free move in a longitudinal direction within the knife's frame. The linear guide rail mechanism is a very efficient way of operating the blade and it is proven to work in many industries, such as medical machines, 3D printers, ball screws and other industrial devices.

In another embodiment of this invention, a knife having a solid handle allows for a fixed blade to move in and out of the solid handle freely by means of a guided system, which can be either achieved by centrifugal force or assisted by a spring. Unlike what is currently know in the industry, this invention makes use of linear guide rail technology, which in return makes the OTF knife last longer over repeated use. The linear guide rail technology is also an advantage in the industry, because it can handle high loads of force applied without warping or damaging the mechanism itself. Another advantage of using a linear guide technology is that it is a significant improvement over the prior art, which cannot handle the extreme loads of force that a bearing carriage can handle.

The linear guide rail technology that is the subject of this invention significantly improves on the prior art by allowing for many different blade profiles. This is a significant advantage in the industry, since people tend to value knives that can house larger blades but keeping the handle relatively small. The linear guide rail technology is an advancement for the knife, since it would allow for virtually no friction between the blade and the housing of the knife handle. Other blade deploying technologies lack the rigidity and wear resistance that linear guide rail technology offers. This invention is a significant improvement on the prior art in the knife industry because it makes the end users product last much longer than previously designed knives.

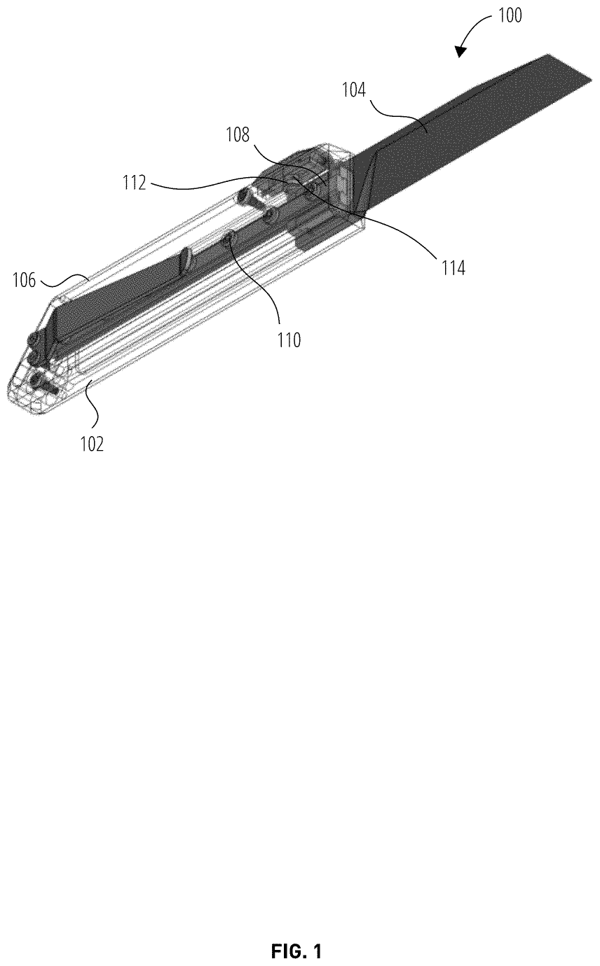

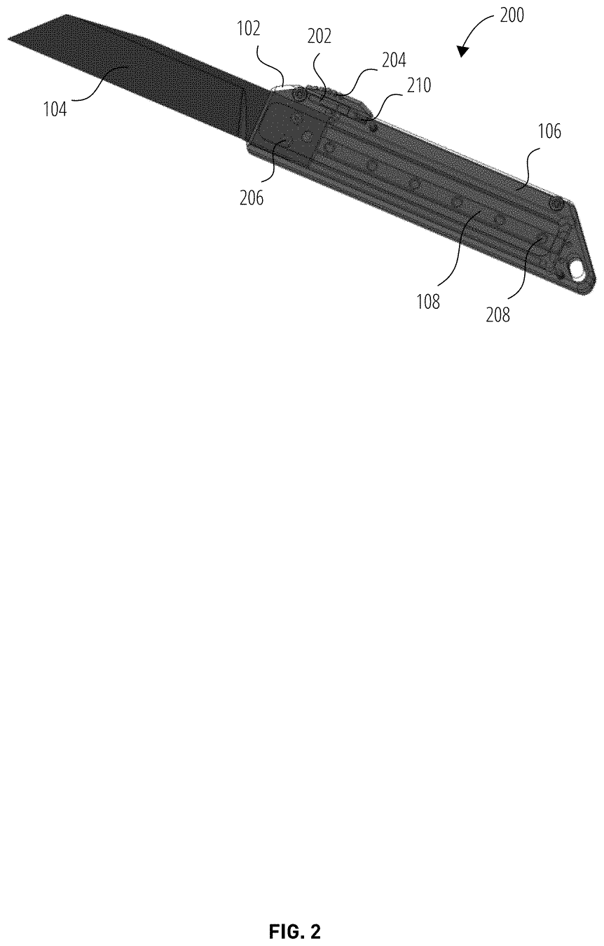

Referring to FIG. 1, the knife blade 104 is attached to the bearing carriage, which keeps the blade fixed in the same location with a very minimal tolerance as it moves along the linear guide rail 108. The linear guide rail 108 is attached to the lower frame-rear 106 of the knife's housing in FIG. 1 using rail fastener/screws 110 that would secure the rail into the tapped hole in rail 208 as shown in FIG. 2. The locking pin spring 114 helps the locking pin 112 secure the knife blade 104. The upper frame-front 102 and lower frame-rear 106 encapsulate the knife 100 mechanism.

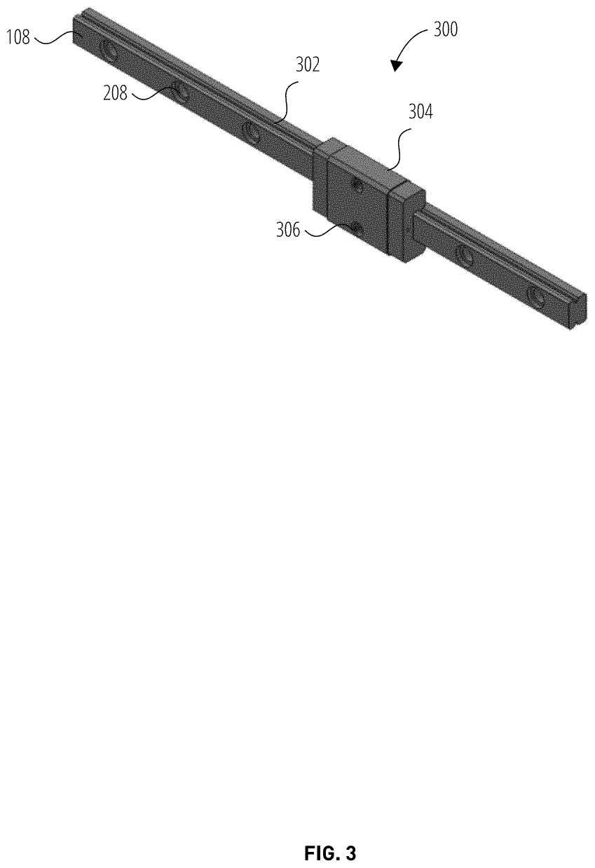

Referring to FIG. 2, the rear unlock/lock button spring 210 is compressed as unlock/lock button 204 moves inside the lock and unlock button channel/slot 202. This allows the locking pin 112 to be disengaged. The knife blade fasteners/screws 206 holds knife blade 104 to the bearing carriage 304 in FIG. 3.

Referring to FIG. 3, the ball bearing groove in liner rail 302 allows the ball bearings internal to the bearing carriage 304 to ride smoothly along the linear guide rail 108. The knife blade fasteners/screws 206 are inserted into tapped holes in carriage 306 to hold the knife blade 104 affixed to the bearing carriage 304.

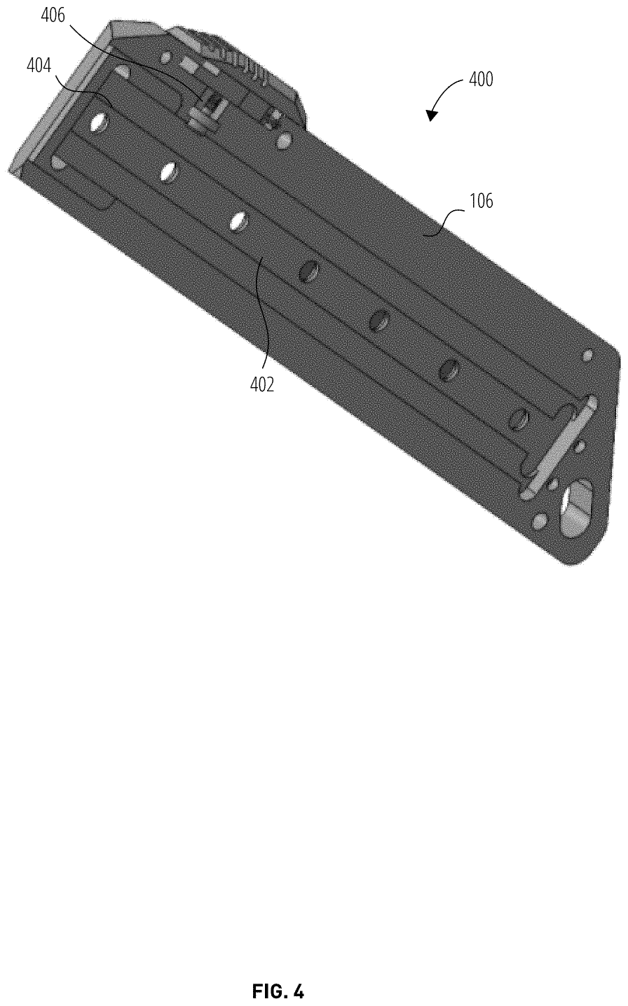

Referring to FIG. 4, the linear guide rail 108 lies inside the slotted channel 402. The linear guide rail 108 registers against the straight edge 404 to maintain a trajectory of knife blade 104 that is parallel to the slotted channel 402. The locking pin 112 and the locking pin spring 114 reside inside the circular slot 406.

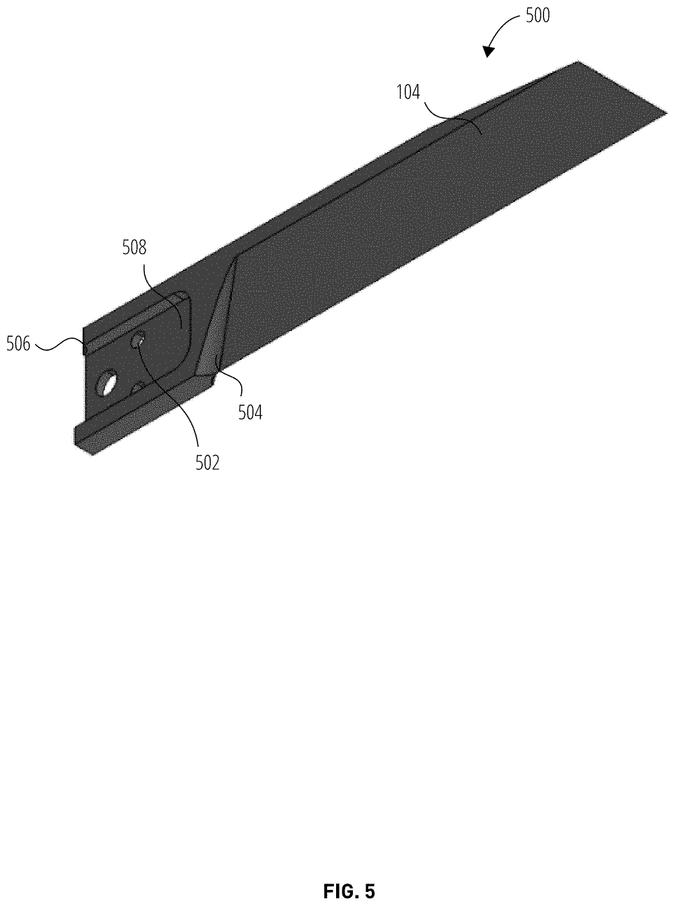

Referring to FIG. 5, the bearing carriage 304 registers inside the guide pocket 508 to keep knife blade 104 from moving side to side. The knife blade fasteners/screws 206 use fastener holes 502 to mount knife blade 104 to the bearing carriage 304. The knife bevel 504 allows the knife blade 104 to cut through material in an easier fashion. The engagement edge 506 allows the locking pin 112 to securely lock the knife blade 104 in place when ejected.

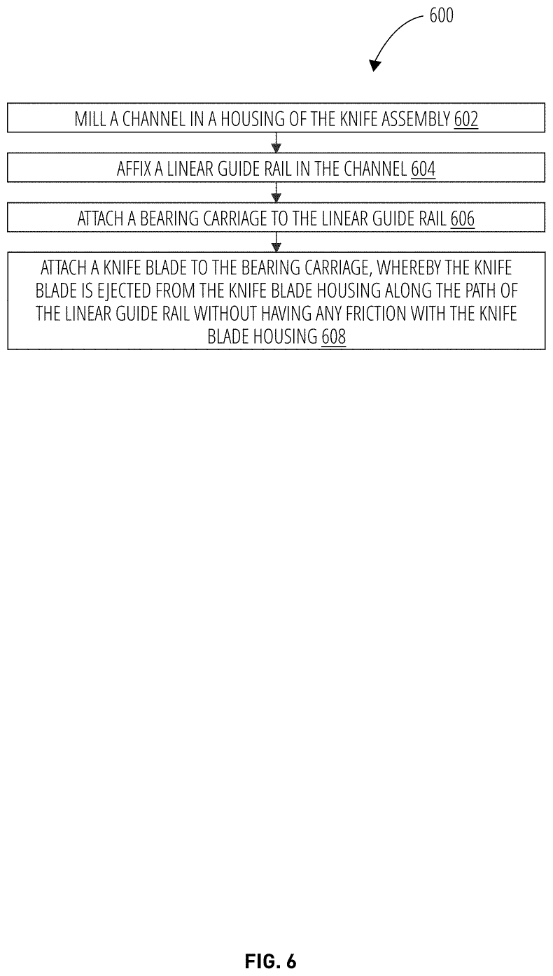

FIG. 6 describes a process of manufacturing this invention, which includes milling a channel in a housing of the knife assembly (602), affixing a linear guide rail in the channel (604), attaching a bearing carriage to the linear guide rail (606), and attaching a knife blade to the bearing carriage, whereby the knife blade is ejected from the knife blade housing along the path of the linear guide rail without having any friction with the knife blade housing (608).

What is claimed is:

1. An out-of-the-front knife assembly, comprising:
a knife housing containing a linear guide rail,
a knife blade attached to a bearing carriage riding on the linear guide rail,
wherein, the knife blade is ejected from the knife housing along the path of the linear guide rail without having any friction with the knife inner housing.

2. The out-of-the-front knife assembly of claim 1 comprising a locking pin for securing the knife blade in an ejected position.

3. The out-of-the-front knife assembly of claim 2 comprising a button to release the locking pin.

4. The out-of-the-front knife assembly of claim 1, wherein the knife blade includes a milled pocket to prevent rotation of the bearing carriage.

5. The out-of-the-front knife assembly of claim 1, wherein a lower frame of the knife housing contains a channel for maintaining a straight trajectory of the knife blade affixed on the bearing carriage along the linear guide rail.

6. The out-of-the-front knife assembly of claim 1, wherein the bearing carriage is self-lubricated and rides on the linear guide rail without the use of ball bearings.

7. A method for manufacturing an out-of-the-front knife assembly, comprising the following steps:
milling a channel in a housing of the knife assembly,
affixing a linear guide rail in the channel,
attaching a bearing carriage to the linear guide rail,
attaching a knife blade to the bearing carriage, whereby the knife blade is ejected from the knife blade housing along the path of the linear guide rail without having any friction with the knife blade housing.

8. The method of claim 7, wherein the milling of the channel takes place in the center of the knife housing.

9. The method of claim 7, wherein the milling of the channel takes place offset from the center of the knife housing.
